(19) United States
(12) Patent Application Publication
(10) Pub. No.: US 2004/0042067 A1
(43) Pub. Date: Mar. 4, 2004

(54) Apparatus and method for duplex optical transport using a co-directional optical amplifier

(76) Inventor: Michael H. Eiselt, Middletown, NJ (US)

Correspondence Address: Schultz & Associates, P.C., One Lincoln Centre, 5400 LBJ Freeway, Suite 525, Dallas, TX, 75240, US

(21) Appl. No.: 10/454,712

(22) Filed: Jun. 3, 2003

Related U.S. Application Data
(60) Provisional application No. 60/386,103, filed on Jun. 4, 2002.

(51) Int. Cl. H01S 3/00

(52) U.S. Cl. 359/344

(57) ABSTRACT

The invention pertains to optical fiber transmission systems, and is particularly relevant to optical transport systems employing optical amplifiers. In particular the invention teaches an apparatus and method that allows cost effective co-directional operation of an optical amplifier to support full duplex traffic.

### CROSS-REFERENCE TO RELATED APPLICATION

This application claims priority to U.S. Provisional Application Serial No. 60/386,103, entitled “Codirectional Erbium Doped Fiber Amplifier”, by Michael H. Eiselt, filed Jun. 4, 2002,

### TECHNICAL FIELD OF THE INVENTION

The invention pertains to optical fiber transmission systems, and is particularly relevant to optical transport systems employing optical amplifiers. In particular the invention teaches an apparatus and method that allows cost effective co-directional operation of an optical amplifier to support full duplex traffic.

### BACKGROUND OF THE INVENTION

A goal of many modern long haul optical transport systems is to provide for the efficient transmission of large volumes of voice traffic and data traffic over trans-continental distances at low costs. Various methods of achieving these goals include time division multiplexing (TDM) and wavelength division multiplexing (WDM). In time division multiplexed systems, data streams comprised of short pulses of light are interleaved in the time domain to achieve high spectral efficiency, high data rate transport. In wavelength division multiplexed systems, data streams comprised of short pulses of light of different carrier frequencies, or equivalently wavelength, are co-propagate in the same fiber to achieve high spectral efficiency, high data rate transport.

The transmission medium of these systems is typically optical fiber. In addition there is a transmitter and a receiver. The transmitter typically includes a semiconductor diode laser, and supporting electronics. The laser may be directly modulated with a data train with an advantage of low cost, and a disadvantage of low reach and capacity performance. After binary modulation, a high bit may be transmitted as an optical signal level with more power than the optical signal level in a low bit. Often, the optical signal level in a low bit is engineered to be equal to, or approximately equal to zero. In addition to binary modulation, the data can be transmitted with multiple levels, although in current optical transport systems, a two level binary modulation scheme is predominantly employed.

Typical long haul optical transport dense wavelength division multiplexed (DWDM) systems transmit 40 to 80 channels at 10 Gbps (gigabit per second) across distances of 3000 to 6000 km in a single 30 nm spectral band. A duplex optical transport system is one in which traffic is both transmitted and received between parties at opposite end of the link. In current DWDM long haul transport systems transmitters different channels operating at distinct carrier frequencies are multiplexed using a multiplexer. Such multiplexers may be implemented using array waveguide grating (AWG) technology or thin film technology, or a variety of other technologies. After multiplexing, the optical signals are coupled into the transport fiber for transmission to the receiving end of the link.

At the receiving end of the link, the optical channels are de-multiplexed using a demultiplexer. Such de-multiplexers may be implemented using AWG technology or thin film technology, or a variety of other technologies. Each channel is then optically coupled to separate optical receivers. The optical receiver is typically comprised of a semiconductor photodetector and accompanying electronics.

The total link distance may in today's optical transport systems be two different cities separated by continental distances, from 1000 km to 6000 km, for example. To successfully bridge these distances with sufficient optical signal power relative to noise, the total fiber distance is separated into fiber spans, and the optical signal is periodically amplified using an inline optical amplifier after each fiber span. Typical fiber span distances between optical amplifiers are 50-100 km. Thus, for example, 30 100 km spans would be used to transmit optical signals between points 3000 km apart. Examples of in-line optical amplifers include erbium doped fiber amplifers (EDFAs) and semiconductor optical amplifiers (SOAs).

A duplex optical transport system is one in which voice and data traffic is both transmitted and received between parties at opposite end of the link. There are several architectures that support duplex operation in fiber optical transport systems. Each suffers from a limitation.

For example, it is known in the art to use a pair of fiber strands to support duplex operation. One fiber strand of the fiber pair supports traffic flow from a first city to a second city while the second strand of the fiber pair supports traffic flow from the second city to the first city. Each strand is comprised of separate optical amplifiers. At low channel counts, this configuration suffers from a limitation in that the system still demands a large number of optical amplifiers that could potentially be twice the amount needed.

As a second example, it is known in the art to use a bidirectional optical amplifier, and in particular a bidirectional EDFA to support duplex operation using a single strand of optical fiber. A limitation of this prior art implementation is that the bidirectional EDFA may begin to lase rather than amplify. Keeping the bidirectional EDFA from lasing, typically carries additional engineering and financial costs, and ultimately limits the reach and capacity of the transport system. It is desirable to use a single amplifier to support duplex operation, without the penalties of a bidirectional EDFA.

### SUMMARY OF THE INVENTION

In the present invention, improvements to optical amplifier deployment are taught in order to provide for duplex operation of an optical transport system. The improvements reduce the number of optical amplifiers in a duplex optical transport system without suffering the penalties present in bi-directional optical amplifiers.

In one aspect of the invention, an apparatus to achieve duplex operation of an optical transport system through co-directional operation of each optical amplifier is taught.

In another aspect of the invention, a method of duplex operation using a co-directional optical amplifier is taught.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic illustration of a co-directional optical amplifier configuration that achieves duplex operation of an optical transport system in accordance with the invention.

FIG. 2 is a flow chart describing a method of duplex operation using a co-directional optical amplifier in accordance with the invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments described herein are merely illustrative of specific ways to make and use the invention and do not delimit the scope of the invention.

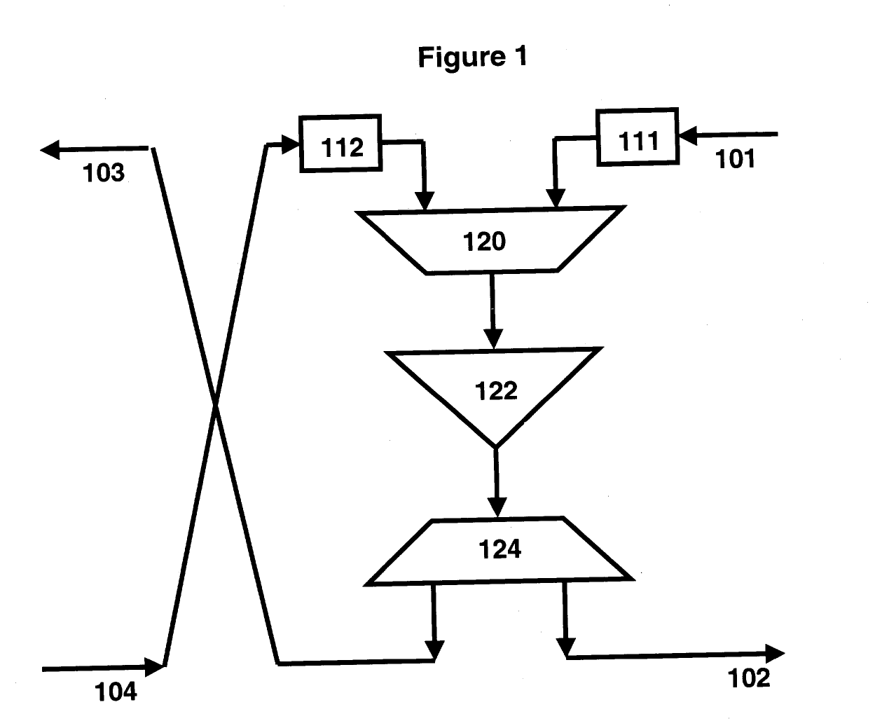

In FIG. 1 is shown a block diagram of a co-directional optical amplifier configuration that achieves duplex operation of an optical transport system. The co-directional optical amplifier configuration comprises a functional arrangement of optical components that serves to amplify the optical signals between spans. Shown in FIG. 1 are fiber span 101, fiber span 102, fiber span 103 and fiber span 104. Fiber span 101 and fiber span 102 together comprise a fiber pair that carries duplex traffic to a first station in a first geographic direction. Fiber span 103 and fiber span 104 together comprise a fiber pair that carries duplex traffic to a second station in a second geographic direction. Fiber span 101 and fiber span 103 carry traffic from the first station in the first geographic direction towards the second station in the second geographic direction. Fiber span 102 and fiber span 104 carry traffic from the second station in the second geographic direction towards the first station in the first geographic direction. Examples of optical transport system components that could comprise a station include an in-line optical amplifier, an optical add-drop multiplexer (OADM) or a transceiver. Fiber span 101, fiber span 102, fiber span 103 and fiber span 104 may be realized by fiber optic strands, wherein the optical fiber is single mode fiber such as SMF-28, LEAF or other type of silica glass fiber. This fiber is typically jacketed and cabled for protection and mechanical ruggedness.

Also shown in FIG. 1 are optical attenuator 111 and optical attenuator 112. Optical attenuator 111 is optically coupled to fiber span 101. Optical attenuator 112 is optically coupled to fiber span 104. Optical attenuator 111 and optical attenuator 112 are optically coupled to wavelength selective optical coupler 120. In a preferred embodiment, optical attenuator 111 and optical attenuator 112 are implemented as variable optical attenuators, which may be realized using a number of technologies, including micro-electromechanical machines (MEMS) variable optical attenuators, thermo-optic based variable optical attenuators, traditional mechanical variable optical attenuators, or other variable optical attenuator technology. In a preferred embodiment, wavelength selective optical coupler 120 may be realized as a thin film optical coupler. In an alternate preferred embodiment, wavelength selective optical coupler 120 may be implemented as an inter-leaver, which may be realized as an etalon, or with birefringent crystals, or other inter-leaver technology.

Also shown in FIG. 1 is optical amplifier 122 and wavelength selective optical de-coupler 124. The input of optical amplifier 122 is optically coupled to wavelength selective optical coupler 120. The output of optical amplifier 122 is optically coupled to wavelength selective optical de-coupler 124. Optical de-coupler 124 is optically coupled to fiber span 102 and also to fiber span 103.

Optical amplifier 122 may be implemented using erbium doped fiber amplifier (EDFA) technology, semiconductor optical amplifier technology (SOA), discrete Raman amplifier technology or other optical amplifier technology. In a preferred embodiment, optical amplifier 122 is a two stage optical amplifier. In the preferred embodiment with the two stage optical amplifier, a dispersion compensation module may be included between the two stages. The dispersion compensator module adjusts the phase information of the optical pulses in order to compensate for the chromatic dispersion in the optical fiber while appreciating the role of optical nonlinearities in the optical fiber. The dispersion compensator module may be realized using optical fiber of an appropriate chemical composition, or using group velocity based dispersion compensator modules including multimode fiber based dispersion compensator module technology.

In a preferred embodiment, wavelength selective optical de-coupler 124 may be realized as a thin film optical de-coupler. In an alternate preferred embodiment, wavelength selective optical coupler 124 may be implemented as an inter-leaver, which may be realized as an etalon, or with birefringent crystals, or other inter-leaver technology.

FIG. 1 shows a basic configuration of a co-directional amplifier that achieves duplex operation of an optical transport system. The configuration of FIG. 1 supports a number of additions and modifications that comprise further aspects of the invention. For example, an equalizing filter may be placed between optical amplifier 122 and wavelength selective optical de-coupler 124. This equalizing filter may be a dynamic equalizing filter based on liquid crystal technology or on MEMS technology.

Another modification of the basic configuration entails the use of a dispersion compensation module for the optical signal in fiber span 101 that is different from the dispersion compensation module in fiber span 104. For example, an additional dispersion compensation module may be placed between either of the outputs of wavelength selective optical de-coupler 124 and the subsequent fiber span. For a second example, different dispersion compensation modules may be placed between each of the outputs of wavelength selective optical de-coupler 124 and the subsequent fiber spans. For a third example, different dispersion compensation modules may be placed at the mid-stage of optical amplifier 122 providing an additional wavelength selective optical de-coupler and an additional wavelength selective optical coupler is used to route appropriately the different optical signals.

Yet another modification of the basic configuration entails the use of a WDM directional coupler in order to adapt the basic configuration for use on a single bidirectional fiber instead of two single direction fibers. In this configuration a WDM directional coupler is placed between and is connected to fiber span 103 and 104. A single directional fiber is also connected to the WDM coupler to allow ingress and egress signals to the configuration. A WDM directional coupler is also placed in between and connected to fiber span 101 and 102. A bidirectional fiber is also operatively coupled to this WDM multiplexer to allow the system to operate. A spectral multiplexer circulator or interleaver can also be used in place of each WDM directional coupler.

FIG. 1 may now be used to understand the operation of the invention to achieve duplex operation of an optical transport system through a co-directional optical amplifier configuration. In operation, fiber span 101 carries an optical signal modulated to represent voice and data traffic from the first station. Upon arrival at optical attenuator 111, the strength of the optical signal from the first station is typically weak, and in need of amplification. Fiber span 104 carries an optical signal modulated to represent voice and data traffic from the second station. The optical signals in fiber span 101 and in fiber span 104 operate on different wavelength channels. Upon arrival at optical attenuator 112, the strength of the optical signal from the second station is typically weak, and in need of amplification. The incoming traffic arriving at optical attenuator 111 and optical attenuator 112 is equalized in power using optical attenuator 111 and optical attenuator 112. The optical signal outputted from optical attenuator 111 and the optical signal outputted from optical attenuator 112 are combined using wavelength selective optical coupler 120. If the optical signal in fiber span 101 occupies a different wavelength sub-band from the optical signal in fiber span 104, then a band-pass filter, potentially realized with thin film filter technology, may be used as wavelength selective optical coupler 120. If the optical signal in fiber span 101 occupies alternating wavelengths from the optical signal in fiber span 104, then inter-leaver technology may used as wavelength selective optical coupler 120. It will be understood by one skilled in the art that the loss of wavelength selective coupler 120 must be designed to be as small as practical, in order to preserve optical signal to noise.

At the output of wavelength selective coupler 120, the optical signal originally in fiber span 101 and the optical signal originally in fiber span 104 are co-propagating, and still distinguishable by their different wavelengths. The co-propagating signals at the output of wavelength selective optical coupler are then coupled into optical amplifier 122, where they are co-directionally amplified. After amplification in optical amplifier 122, the co-propagating signals are separated using wavelength selective de-coupler 124. If the optical signal in fiber span 101 occupies a different wavelength sub-band from the optical signal in fiber span 104, then a band-pass filter, potentially realized with thin film filter technology, may be used as wavelength selective optical de-coupler 124. If the optical signal in fiber span 101 occupies alternating wavelengths from the optical signal in fiber span 104, then inter-leaver technology may used as wavelength selective optical de-coupler 124. One output of wavelength selective optical de-coupler 124 contains the amplified optical signal originally in fiber span 101, and this output is directed into fiber span 103 for transmission to said second station. The other output of wavelength selective optical de-coupler 124 contains the amplified optical signal originally in fiber span 104, and this output is directed into fiber span 102 for transmission to said first station.

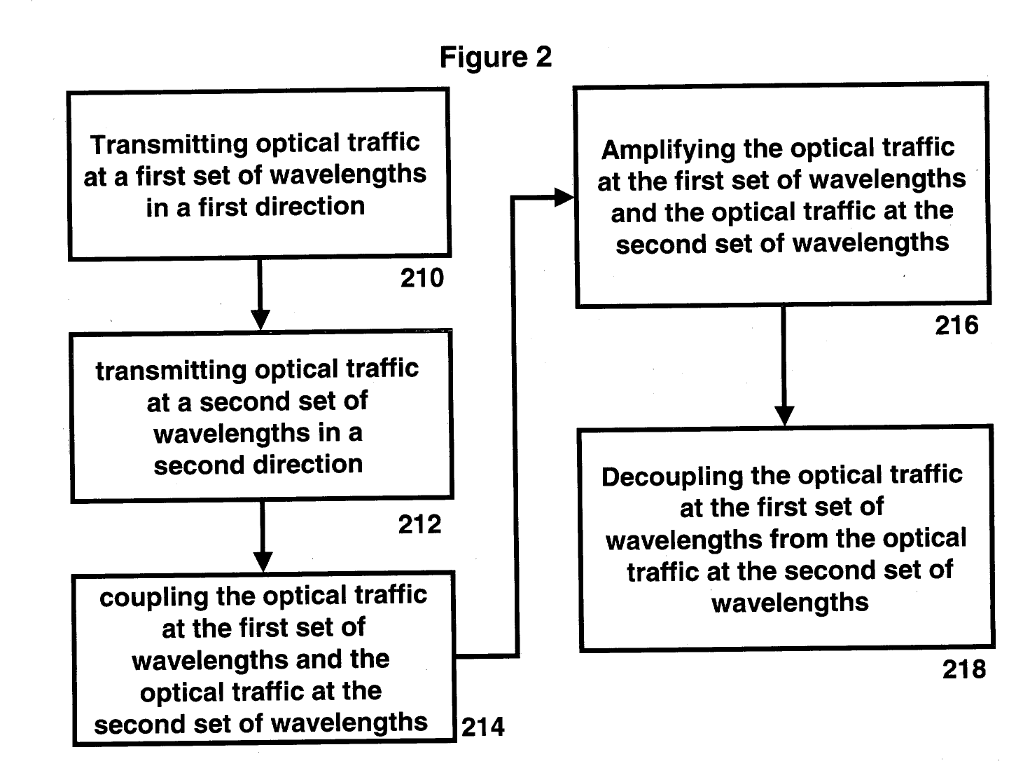

In FIG. 2 is a flow chart illustrating the method of achieving duplex operation in an optical transport system using a co-directional optical amplifier. The method comprises a first step 210 of transmitting optical traffic at a first set of wavelengths in a first direction. The method further comprises a second step 212 of transmitting optical traffic at a second set of wavelengths in a second direction. Together, the optical traffic at the first set of wavelengths and the optical traffic at the second set of wavelengths provide duplex operation in an optical transport system. The method further comprises the third step 214 of coupling the optical traffic at the first set of wavelengths and the optical traffic at the second set of wavelengths using a wavelength selective optical coupler 120. The method further comprises a fourth step 216 of amplifying the optical traffic at the first set of wavelengths and the optical traffic at the second set of wavelengths in optical amplifier 122 wherein the optical traffic at the first set of wavelengths and the optical traffic at the second set of wavelengths propagate through optical amplifier 122 in the same direction. The method further comprises a fifth step 218 of decoupling the optical traffic at the first set of wavelengths from the optical traffic at the second set of wavelengths using a wavelength selective de-coupler.

FIG. 2 shows a basic method for achieving duplex operation using a co-directional optical amplifier. The method of FIG. 2 supports a number of additions and modifications that comprise further aspects of the invention. For example, an additional step may be made of equalizing the power of the optical traffic at the first set of wavelengths with the optical traffic at the second set of wavelengths prior to amplification. For a second example, an additional step may be made of equalizing the power in each channel after amplification. For a third example, an additional step may be made of compensating for dispersion.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A co-directional optical amplifier comprising:
a first optical signal;
a second optical signal;
a wavelength selective optical coupler, to couple the first and second optical signals;
an optical amplifier optically coupled to said wavelength selective optical coupler to amplify the first and second optical signals; and
a wavelength selective optical de-coupler optically coupled to the output of said optical amplifier to decouple the first and second optical signals.

2. The co-directional optical amplifier of claim 1 further comprising an optical attenuator coupled to said first optical signal and coupled to said wavelength selective optical coupler to equalize the power of the first optical signal.

3. The co-directional optical amplifier of claim 1 further comprising an optical attenuator coupled to said second optical signal and coupled to said wavelength selective optical coupler to equalize the power of the first optical signal.

4. The co-directional optical amplifier of claim 1 further comprising at least one dispersion compensation module coupled to the wavelength selective optical de-coupler in the path of the first optical signal.

5. The co-directional optical amplifier of claim 1 further comprising at least one dispersion compensation module coupled to the wavelength selective optical de-coupler in the path of the second optical signal.

6. The co-directional optical amplifier of claim 1 further comprising a gain equalizer coupled to the optical amplifier and the selective optical decoupler.

7. The co-directional optical amplifier of claim 1 wherein the optical amplifier is a semiconductor optical amplifier.

8. The co-directional optical amplifier of claim 1 wherein the optical amplifier is a discrete Raman amplifier.

9. The co-directional optical amplifier of claim 1 wherein the optical amplifier is an erbium doped optical amplifier.

10. The co-directional optical amplifier of claim 9 wherein the erbium doped optical amplifier comprises a first stage and a second stage.

11. The co-directional optical amplifier of claim 10 further comprising a dispersion compensation module located between the stages of the two stage optical amplifier.

12. The co-directional optical amplifier of claim 10 further comprising:
a second optical decoupler connected to the output of the first stage to decouple the first and second optical signals;
a first dispersion compensation module connected to the second optical decoupler in the path of the first optical signal;
a second dispersion compensation module connected to the second optical decoupler in the path of the second optical signal; and
a second optical coupler connected to the first and second dispersion compensation modules to couple the first and second optical signals before entering the input of the second stage.

13. The co-directional optical amplifier of claim 11 further comprising at least one dispersion compensation module coupled to the wavelength selective optical de-coupler.

14. The apparatus of claim 1 wherein the first optical signal occupies a different wavelength sub-band from the second optical signal.

15. The apparatus of claim 1 wherein the first optical signal occupies alternating wavelengths from the second optical signal.

16. A method of duplex operation using a co-directional optical amplifier comprising the steps of:
transmitting optical traffic at a first set of wavelengths in a first direction;
transmitting optical traffic at a second set of wavelengths in a second direction;
coupling the optical traffic at the first set of wavelengths and the optical traffic at the second set of wavelengths using a wavelength selective optical coupler;
amplifying the optical traffic at the first set of wavelengths and the optical traffic at the second set of wavelengths in an optical amplifier wherein the optical traffic at the first set of wavelengths and the optical traffic at the second set of wavelengths propagate through said optical amplifier in the same direction; and
decoupling the optical traffic at the first set of wavelengths from the optical traffic at the second set of wavelengths using a wavelength selective de-coupler.

17. The method of claim 16 wherein the optical traffic at the first set of wavelengths and the optical traffic at the second set of wavelengths is transmitted on the same fiber.

18. The method of claim 16 further comprising the step of equalizing the power of the optical traffic at the first set of wavelengths to the power of the optical traffic at the second set of wavelengths using at least one optical attenuator.

19. The method of claim 16 further comprising the step of equalizing the gain.

20. The method of claim 16 further comprising the step of compensating for dispersion.

21. A co-directional optical amplifier comprising:
a first optical fiber carrying a first optical signal in a first direction;
a second optical fiber carrying a second optical signal in a second direction;
the first fiber connected to a first optical attenuator;
the second fiber connected to a second optical attenuator;
the first and second optical attenuators connected to an optical coupler;
the optical coupler connected to an optical amplifier to amplify the first and second optical signals into a first and second amplified optical signal;
the optical amplifier connected to an optical decoupler;
the optical decoupler connected to a third optical fiber to carry the first amplified optical signal; and
the optical decoupler connected to a fourth optical fiber to carry the second amplified optical signal.

22. The co-directional optical amplifier of claim 21 wherein the first optical signal occupies a different wavelength sub-band from the second optical signal.

23. The co-directional optical amplifier of claim 21 wherein the first optical signal occupies alternating wavelengths from the second optical signal.

24. The co-directional optical amplifier of claim 21 further comprising an equalizing filter coupled to the optical amplifier and the optical de-coupler to equalize the power of the first optical signal.

25. The co-directional optical amplifier of claim 21 further comprising an equalizing filter coupled to the optical amplifier and the optical de-coupler to equalize the power of the first optical signal and the second optical filter.

26. The co-directional optical amplifier of claim 21 further comprising at least one dispersion compensation module coupled to the wavelength selective optical de-coupler in the path of the first optical signal.

27. The co-directional optical amplifier of claim 21 further comprising at least one dispersion compensation module coupled to the wavelength selective optical de-coupler in the path of the second optical signal.

28. The co-directional optical amplifier of claim 27 wherein the amplifier comprises a first stage and a second stage.

29. The co-directional optical amplifier of claim 28 further comprising a dispersion compensation module located between the first stage and the second stage.

30. The co-directional optical amplifier of claim 28 further comprising:
a second optical decoupler connected to the output of the first stage to decouple the first and second optical signals;
a first dispersion compensation module connected to the second optical decoupler in the path of the first optical signal;
a second dispersion compensation module connected to the second optical decoupler in the path of the second optical signal; and
a second optical coupler connected to the first and second dispersion compensation modules to couple the first and second optical signals before entering the input of the second stage.

31. The co-directional optical amplifier of claim 29 further comprising at least one dispersion compensation module coupled to the wavelength selective optical de-coupler.

32. The co-directional optical amplifier of claim 21 wherein the first optical fiber and the second optical fiber are connected to a directional coupler de-coupler.

33. The co-directional optical amplifier of claim 21 wherein the third optical fiber and the forth optical fiber are connected to a directional coupler de-coupler.

34. A co-directional amplifier comprising:
a first coupler de-coupler decoupling a unamplified eastbound signal from a first fiber span;
a second coupler de-coupler decoupling an unamplified westbound signal from a second fiber span;
a wavelength selective coupler coupling the unamplified eastbound signal and the unamplified westbound signal;
an amplifier amplifying the unamplified eastbound signal into an amplified eastbound signal and the unamplified westbound signal into an amplified westbound signal;
a wavelength selective de-coupler decoupling the amplified eastbound signal and the amplified westbound signal;
the first coupler-decoupler coupling the amplified westbound signal to the first fiber span;
the second coupler-decoupler coupling the amplified westbound signal to the second fiber span.

35. The co-directional optical amplifier of claim 34 further comprising an optical attenuator coupled to the unamplified eastbound signal and coupled to said wavelength selective optical coupler to equalize the power of the unamplified eastbound signal.

36. The co-directional optical amplifier of claim 34 further comprising an optical attenuator coupled to the unamplified westbound signal and coupled to said wavelength selective optical coupler to equalize the power of the unamplified westbound signal.

37. The co-directional optical amplifier of claim 34 further comprising at least one dispersion compensation module coupled to the wavelength selective optical de-coupler in the path of the amplified eastbound signal.

38. The co-directional optical amplifier of claim 34 further comprising at least one dispersion compensation module coupled to the wavelength selective optical de-coupler in the path of the amplified westbound signal.

39. The co-directional optical amplifier of claim 34 further comprising a gain equalizer coupled to the optical amplifier and the selective optical decoupler.

40. The co-directional optical amplifier of claim 34 wherein the optical amplifier is a semiconductor optical amplifier.

41. The co-directional optical amplifier of claim 34 wherein the optical amplifier is a discrete Raman optical amplifier.

42. The co-directional optical amplifier of claim 34 wherein the optical amplifier is an erbium doped optical amplifier.

43. The co-directional optical amplifier of claim 42 wherein the erbium doped optical amplifier comprises a first stage with a first stage input and a first stage output and a second stage with a second stage input and a second stage output.

44. The co-directional optical amplifier of claim 43 further comprising a dispersion compensation module located between the stages of the two stage optical amplifier.

46. The co-directional optical amplifier of claim 43 further comprising:
a second optical decoupler connected to the output of the first stage;
a first dispersion compensation module connected to the second optical decoupler;
a second dispersion compensation module connected to the second optical decoupler; and,
a second optical coupler connected to the first and second dispersion compensation modules and the input of the second stage.

46. The co-directional optical amplifier of claim 45 further comprising at least one dispersion compensation module coupled to the wavelength selective optical de-coupler.

47. The apparatus of claim 1 wherein the unamplified eastbound signal occupies a different wavelength sub-band from the unamplified westbound signal.

48. The apparatus of claim 1 wherein the unamplified eastbound signal occupies alternating wavelengths from the unamplified westbound signal.
